(19) United States
(12) Patent Application Publication
(10) Pub. No.: US 2023/0025055 A1
(43) Pub. Date: Jan. 26, 2023

(54) APPARATUS AND METHOD FOR ROBOTIC VENDING MACHINE

(71) Applicant: Naimishkumar B. Harpal, Lynnwood, WA (US)

(72) Inventor: Naimishkumar B. Harpal, Lynnwood, WA (US)

(21) Appl. No.: 17/385,723

(22) Filed: Jul. 26, 2021

(51) Int. Cl. G07F 9/02; G07F 9/00; G07F 11/16; G06Q 50/00; H04W 4/80

(52) U.S. Cl. CPC G07F 9/0235; G07F 9/001; G07F 9/009; G07F 11/16; G06Q 50/01; H04W 4/80

(57) ABSTRACT

A system and method for a vending machine is provided. One embodiment has a user interface configured to receive a plurality of user selections of a plurality of food products of interest from the user; a robotic system configured to transport a container to a plurality of food tanks to receive food products dispensed from selected ones of the plurality of food tanks, wherein a unique machine readable code is printed on an outside surface of at least one of the container and a container seal; and a scanner configured to scan the machine readable code. Wherein prior to delivery of the container with the machine readable code, the controller system controls the robotic system so that the scanner acquires the machine readable code, and wherein the controller system associates at least food product information with the received machine readable code information.

### BACKGROUND OF THE INVENTION

Consumer preferences are trending towards both a healthier diet and a customized experience. For example, consumers are preferring healthy salads over fast foods. Healthy smoothies are being chosen over sodas.

Many brick-and-mortar venues are hosting self-serve salad bars that enable a consumer to build a customized salad based on their preferences. However, exposing the salad ingredients in an open air salad bar creates potential health issues and spoilage issues. Further, prices charged for a self-made salad is typically based on final weight. Also, individual ingredient costs vary widely such that the sale price per unit weight has to reflect a blended product cost rather than actual product cost. Further, salad bars may be relatively expensive to maintain in view of the operating costs, such as, but not limited to, rent rates (measured in dollars per square foot), employee pay and benefits, and spoilage.

Smoothie brick-and-mortar venues can be found in locations with high consumer traffic, such as at shopping malls, tourist attractions, sporting venues, and the like. Such smoothie shops are able to provide customized smoothies based on the preferences of each individual consumer. However, such smoothie brick-and-mortar shops incur relatively high operating costs in the form of rent and in the form of employee pay and benefits.

Commercially available smoothie and juice robotic vending machines are becoming increasingly available that solve some of the above-described deficiencies experienced by the brick-and-mortar venues. However, the personal interaction experience of the user is limited to the time that they are operating the robotic vending machine.

Accordingly, in the arts of food services, there is a need in the arts for improved methods, apparatus, and systems for providing a customized robotic vending machine experience for consumers.

### SUMMARY OF THE INVENTION

Embodiments of the have a user interface configured to receive a plurality of user selections of a plurality of food products of interest from the user; a robotic system configured to transport a container to a plurality of food tanks to receive food products dispensed from selected ones of the plurality of food tanks, wherein a unique machine readable code is printed on an outside surface of at least one of the container and a container seal; and a scanner configured to scan the machine readable code. Wherein prior to delivery of the container with the machine readable code, the controller system controls the robotic system so that the scanner acquires the machine readable code, and wherein the controller system associates at least food product information with the received machine readable code information.

### BRIEF DESCRIPTION OF THE DRAWINGS

The components in the drawings are not necessarily to scale relative to each other. Like reference numerals designate corresponding parts throughout the several views.

FIG. 1 is a front view of a robotic vending machine system.

FIG. 2 is side view of the robotic vending machine with a user operating the robotic vending machine system.

FIG. 3 is a front view of the interior of the robotic vending machine system.

FIG. 4 is a side view of the interior of the robotic vending machine system.

FIG. 5 is a diagram of an example robotic arm and the robot arm supports,

FIG. 6 is a block diagram of an example controller system that manages operation of an embodiment of the robotic vending machine.

FIG. 7 is a block diagram illustrating components of the robotic vending machine system and various electronic devices that the robotic vending machine system is communicatively coupled to.

### DETAILED DESCRIPTION

FIG. 1 is a front view of a robotic vending machine system TOO. Embodiments of the robotic vending machine system 100 provide customized food products to a user based upon one or more user requests. Embodiments of the robotic vending machine system 100, after preparation of the food, delivers the prepared food product to the user in a suitable container. The exterior surface of the container include a scannable code, such as, but not limited to, a matrix bar code, quick response (QR) code, alphanumerical text, or the like. The scannable code is associated with the user's robotic vending machine order.

After delivery of the prepared food product, the user may scan the code using their mobile device. Then, the robotic vending machine system 100 may communicate food product information (dietary information, caloric information, and/or nutritional information) to the user's mobile device and/or to another electronic device, such as the user's personal computer, laptop, notebook or the like. Further, the food produce information may be shared with a social media system that the user is a member of. Also, the user may input comments using their mobile electronic device and/or another electronic device. The comments are associated with the food product information and are stored for later reference or use.

The disclosed systems and methods for robotic vending machine system 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for the robotic vending machine system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components. “Secured to” means directly connected without intervening components.

“Communicatively coupled” means that an electronic device exchanges information with another electronic device, either wirelessly or with a wire based connector, whether directly or indirectly through a communication network 108. “Controllably coupled” means that an electronic device controls operation of another electronic device.

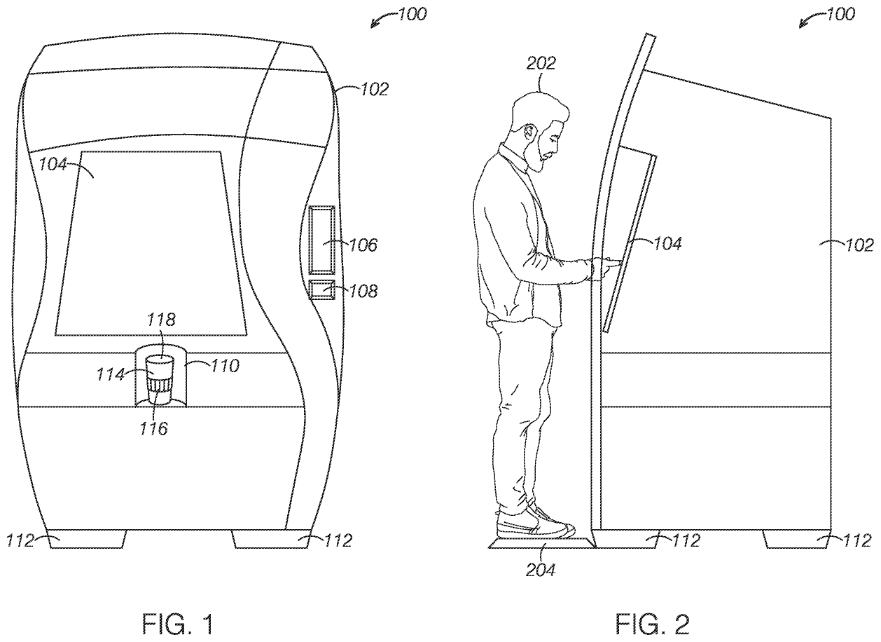

Returning to FIG. 1, disposed on the front surface of the robotic vending machine 102 is a touch sensitive display 104, a payment processing device 106, a scanning device 108, a delivery tray 110 (interchangeably referred to herein as a deliver box or the like), and an optional base 112. FIG. 2 is side view of the robotic vending machine 102 with a user 202 operating the example embodiment of the robotic vending machine system 100.

The touch sensitive display 104, interchangeably referred to herein as a user interface, presents ingredient selection options and/or container size options to the user 202, and then receives the users' ingredient selection and container size selection. Other supplemental information may also be presented on the touch sensitive display 104, such as food product information. Additionally, or alternatively, images associated with each ingredient and/or the finished prepared food product may be presented to the user 202 on the touch sensitive display 104. Further, food product cost information may be presented to the user 202. Alternatively, or additionally, other user input (I/O) devices may be used to receive under inputs, such as buttons, switches, keyboard, roller track halls, a user's mobile device, smart phone, or the like.

As the user 202 begins their ingredient selection, embodiments of the robotic vending machine system 100 track the food product information for each selected ingredient, the cost associated with the selected ingredient, the amount, and/or the weight of each selected ingredient. As each ingredient is selected, the food product information, cost, and/or presented images may be optionally updated so that the user 202 can interactively view current information about their personally designed prepared food product. If the user 202 removes a previously selected ingredient, the ingredient may be removed and the information presented on the touch sensitive display 104 may be updated.

Once the user 202 has completed their ingredient selection, the user's order is confirmed, Then, the user 202 pays for their selected prepared food product via the payment processing device 106. Any suitable payment device, or number of payment processing devices 106, now known or later developed are intended to be within the scope of this disclosure and to be protected by the accompanying claims. Non-limiting examples of the payment processing device 106 include credit/debit/gift card readers, cash payment devices, contactless scanning devices, tap devices, or the like. Some embodiments may include a change or coin return device. In some instances, the user 202 may pay using a payment app on their mobile device which is scanned by the scanning device 10l or that is otherwise communicated to the robotic vending machine 102.

Once the user 202 has paid for their customized prepared food product, the robotic vending machine 102 prepares the food product using the selected ingredients and other base ingredients, such as ice when the prepared food product is a smoothie. The completed prepared food product is delivered to the user 202 in a sealed container 114 at the delivery tray 110.

Some embodiments may include a weight sensitive standing mat 204 communicatively coupled to the base 112 or another component of the robotic vending machine 102. When the user 202 is not present, the robotic vending machine system 100 may transition into a sleep mode of operation to conserve power. When the user 202 approaches the robotic vending machine 102 and steps onto the standing mat 204, the user's weight actuates the standing mat 204 that communicates a signal to the robotic vending machine 102 indicating the user's presence. In response, the robotic vending machine 102 may transition out of the sleep mode into an operating mode.

In the various embodiments, the container 114 includes a machine readable code 116 on the exterior of the container. The code 116 is unique to each container 114, The robotic vending machine 102 associates the code 116 with the user's prepared food product. The code 116 may optionally include various information pertaining to their purchased prepared food product. Additionally, or alternatively, the user 202, using their mobile device (not shown), may acquire the code 116 by scanning or photographing the code 116. The user 202 may the access this information from the robotic vending machine system 100 in a variety of manners on different electronic devices as explained in greater detail hereinbelow.

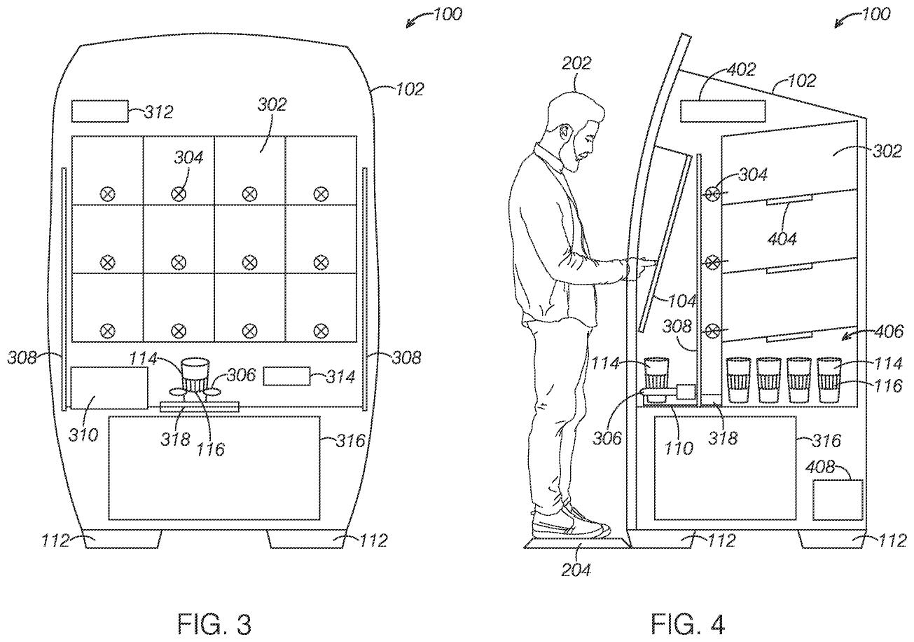

FIG. 3 is a front view of the interior of the robotic vending machine system 100. The interior of the non-limiting robotic vending machine 102 comprises a plurality of food ingredient storage tanks 302, a plurality of food ingredient tank taps 304, a robotic arm 306, robotic arm support 308, a sealing machine 310, an optional image capture device 312, a code scanner 314, an optional refrigeration unit 316, and a food product processing unit 318. The robotic arm 306 and the robotic arm support 308 are generically referred to herein as a robotic system. FIG. 4 is a side view of the interior of the robotic vending machine system 100. The interior of the robotic vending machine 102 further comprises a controller system 402, an optional tank weight scale 404, a container storage unit 406 with a plurality of containers 114 each with a unique code 116, and a power unit 408 that provides power to the various components. Other robotic vending machines 102 may include some, or may omit some, of the above-described components. Further, additional components not described herein may be included in alternative embodiments.

In practice, after the user 202 has specified their ingredients of interest and has paid for their prepared food product, the robotic vending machine 102 begins the process of preparing the food product. A container 114 is retrieved from the container storage unit 406 by the robotic arm 306. The robotic arm 306, grasping the container 114, moves along the robot arm supports 308 to position the container 114 proximate to the food ingredient tank tap 304 that dispenses a user-specified ingredient or base ingredient from the food ingredient storage tank 302.

In some embodiments, the container storage unit 406 is configured to store eating utensils. The eating utensils, such as forks, spoons, knives or the like, can be dispensed to the user 202 with delivery of their prepared food product.

The controller system 402 actuates the food ingredient tank tap 304 so that the container 114 acquires the user specified ingredients and/or base ingredient. In some instances, such as when a liquid or slurry is one of the specified ingredients, the controller system 402 may actuate (open) the food ingredient tank tap 304 for a predefined period of time so that the container 114 acquires the desired amount of liquid or slurry. Alternatively, or additionally, the controller system 402 may actuate the food ingredient tank tap 304 while receiving weight information from the tank weight scale 404. The controller system 402 closes the food ingredient tank tap 304 when a predefined weighed amount of the ingredient has been added into the container 114.

When all of the user specified ingredients and the base ingredients, if any, have been placed into the container 114, the robotic arm 306 moves the filled container 114 to the food product processing unit 318. Here, the food product processing unit 318 may perform various operations to prepare the final prepared food product in accordance with the specifications of the user 202. For example, the food product processing unit 318 may shake the container 114 to mix the pre-chopped or pre-cut ingredients, such as when the prepared food product is a salad or the like. Alternatively, or additionally, the food product processing unit 318 may blend, whip, mix, chop, stir, and/or shake the ingredients, such as when the prepared food product is a smoothie, shake, or other liquid or slurry type food product. Additionally, or alternatively, the food product processing unit 318 may heat the prepared food product, such as when the prepared food product is a sandwich, soup, or other food product that is preferably served hot or warm. Optionally, the food product processing unit 318 may weigh the container 114 and the ingredients therein to ensure that the user 202 is receiving an intended weight of the provided prepared food product.

When the food product has been prepared by the food product processing unit 318, the robotic arm 306 moves the container 114 to the sealing machine 310 where the sealing machine 310 seals the top of the container 114 with container seal 118, such as a lid, cap, foil seal, plastic seal, or the like. Then, the robotic arm 306 places the sealed container 114 into the delivery tray 110 for retrieval by the user 202.

In some embodiments, the code 116 is on an exterior surface of the container seal 118. Some embodiments may include a printer that prints the code 116 on the container and/or the seal 118.

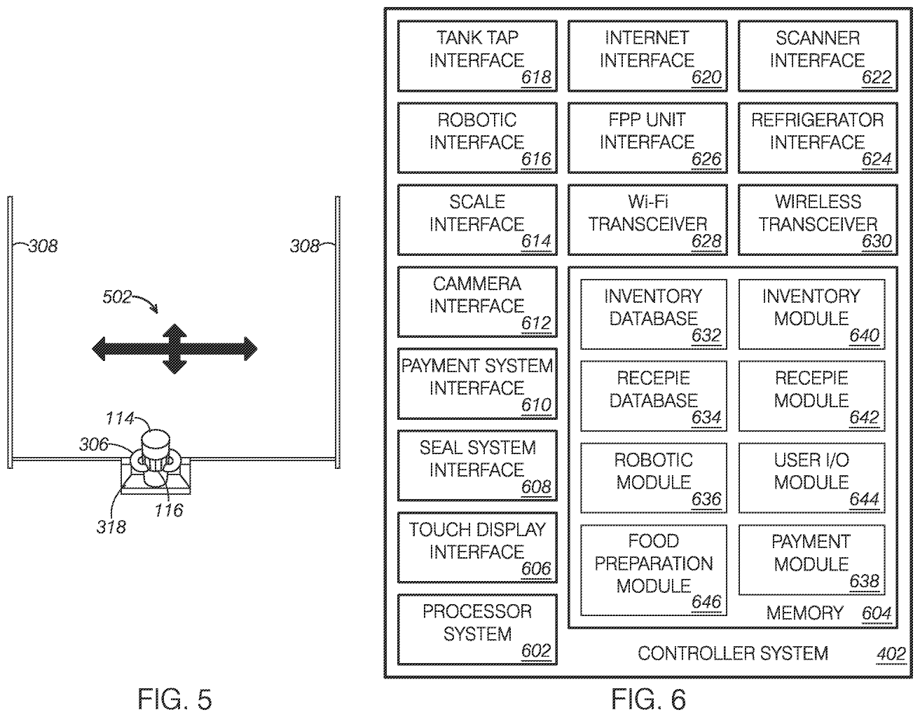

FIG. 5 is a diagram of an example robotic arm 306 and the robotic arm supports 308. The robotic arm 306 is controllably coupled to the food product processing unit 318. The food product processing unit 318 controls the robotic arm 306 so as to move the robotic arm 306 along the robotic arm supports 308 in an up/down and right/left direction (as indicated by the direction arrows 502). The illustrated example robotic system is intended to illustrate one of the many various types of robotic systems that may be used by the robotic vending machine 102. Any suitable robotic system now known or later developed may be used in the various embodiments, and are intended to be protected by the accompanying claims.

FIG. 6 is a block diagram of an example controller system 402 that manages operation of an embodiment of the robotic vending machine 102. The non-limiting example controller system 402 comprises a processor system 602, a memory 604, a touch display interface 606, a seal system interface 608, a payment system interface 610, a camera interface 612, a scale interface 614 a robotic interface 616, a tank tap interface 618, an internet interface 620, a scanner interface 622, a refrigerator interface 624, a food product processing (FPP) unit interface 626, an optional Wi-fi transceiver 628, and an optional wireless transceiver 630. The memory 604 includes regions for storing an inventory database 632, an optional recipe database 634, a robotic module 636, a payment module 638, an inventory module 640, a recipe module 642, a user input/output (I/O) module 644, and a food preparation module 646. In some embodiments, the robotic module 636, the payment module 638, the inventory module 640, the recipe module 642, the user I/O module 644, and/or the food preparation module 646 may be integrated together, and/or may be integrated with other logic. In other embodiments, some or all of these memory and other data manipulation functions may be provided by using a remote server or other electronic devices suitably connected via the Internet or otherwise to the robotic vending machine system 100. Other controller systems 402 may include some, or may omit some, of the above-described media processing components. Further, additional components not described herein may be included in alternative embodiments.

The processor system 602, executing the user I/O module 644, processes the ingredients selected by the user 202 entered using the touch sensitive display 104. The information from the touch sensitive display 104 is received at the touch display interface 606. An ongoing list of the user's selected ingredients is generated by the processor system 602 and is stored in the memory 604.

The processor system 602, executing the payment module 638, receives payment information from the payment processing device 106 via the payment system interface 610. Once payment is confirmed, the controller system 402 initiates the process of preparing the food product.

The processor system 602, executing the recipe module 642, optionally identifies or generates a recipe for making the prepared food product in accordance with the user-specified ingredients. For example, the generated or accessed recipe (that is stored in the optional recipe database 634 or that is accessed over the Internet) may specify an order in with the specified ingredients and/or base ingredients are to be placed into the container 114, and/or may specify what operations the food product processing unit 318 will have to take to prepare the food product.

The processor system 602, executing the food preparation module 646, then determines a food product order. The food product order defines a filling order in that defines an ingredient order in which the container 114 will be filled with the user-specified ingredients and any base ingredients. The filling order preferably is based on a selected recipe that is associated with the user's food product order.

The processor system 602, executing the robotic module 636, then communicates control signals via the robotic interface 616 to actuate (control) the motors of the robotic arm 306 in accordance with a filling order defined for preparation of the user's food product. Accordingly, the robotic arm 306 moves the container 414 to the various food ingredient storage tanks 302 so that the ingredients can be placed into the container 114 in the defined filling order. Once the container 114 is proximate to one of the food ingredient tank taps 304, the processor system then communicates control signals, via the tank tap interface 618, so that the food ingredient tank taps 304 are controlled to dispense the ingredient from the food ingredient storage tank 302.

The processor system 602 then operates the robotic arm 306 to move the container 114 to the food product processing unit 318. Then, then, the processor system 602 communicates control signals, via the food product processing unit interface 626, so that the food product processing unit 318 prepares the food product in accordance with the generated recipe that is associated with the user's food product order.

After preparation of the food product has been completed, the container 114 with the prepared food product is moved to the sealing machine 310. The processor system 602 provides control signals to the sealing machine 310, via the seal system interface 608, to operate the sealing machine 310 to seal the container 114.

In some embodiments, the image capture device 312 captures still or video images of the robotic arm 306 filling the container with the user-specified ingredients and/or images of the food product processing unit 318 preparing the food product. The captured image information is communicated to the controller system 402, via the camera interface 612. The image information is processed by the processor system 602, and is them communicated to the touch sensitive display 104, via the touch display interface 606, for presentation to the user 202. The captured image information may be stored. The presented images enable the user 202 to confirm that the food product is being prepared in accordance with their order. And, presenting the images to the user 202 may enhance their experience of using the robotic vending machine 102 to prepare their tool product. Here, the user 202 enjoys a five sense experience (vision, listening, smell, taste and touch).

Additionally, or alternatively, the image capture device 312 may capture one or more images of the user 202. Facial recognition algorithms may be used to identify the user 202. Once identified, a process of assisting the user 202 may be initiated. For example, the user 202 may be greeted and/or historical use information or other personal information may be used to generate a food product recommendation. Or, personal information and/or billing information may be accessed to facilitate order processing.

At some point during the food product preparing process, the robotic arm 306 moves the container 114 proximate to the code scanner 314. The code scanner 314 reads the unique code 116 (or acquires an image of the code 116) that is on the exterior surface of the container 114. The code information corresponding to the code 116 is communicated to the controller system 402, via the scanner interface 622. The code information may be used in a variety of manners, as described in detail herein.

In alternative embodiments, other code-based means may be used to identify the container 114. For example, RFID vices and system may be used to identify a container 114. Then a corresponding code may be generated by the controller system 402 and presented on the touch sensitive display 104.

In some embodiments, the tank weight scale 404 weighs the content of the ingredients residing in the food ingredient storage tank 302. The weight information is communicated to the controller system 402, via the scale interface 614. In some embodiments, the change in weight is measured while the food ingredient tank tap 304 is opened to discharge a food ingredient into the container 114. Accordingly, the weight of the discharged ingredient can be determined to ensure a predefined amount of the ingredient has been added into the container 114. In some embodiments, the weight and/or amount (computed based on the weight) can be tracked in each of the plurality of food ingredient storage tanks 302 by the processor system 602 executing the inventory module 640. The weight and/or amount information of each ingredient can then by tracked and stored in the inventory database 632. Additionally, or alternatively, if the remaining weight of the ingredient in a food ingredient storage tank 302 drops below some predefined threshold, the processor system 602 can initiate a reordering notification so that the operators of the robotic vending machine 102 will be notified that the ingredient needs to be replenished.

In some embodiments, the refrigeration unit 316 is used to keep some or all of the ingredients at a cool and/or freezing temperature. The processor system 602 may regulate temperature of the ingredients in one or more of the food ingredient storage tanks 302. The processor system 602 communicates control signals, via the refrigerator interface 624, to control the operating temperature of the refrigeration unit 316.

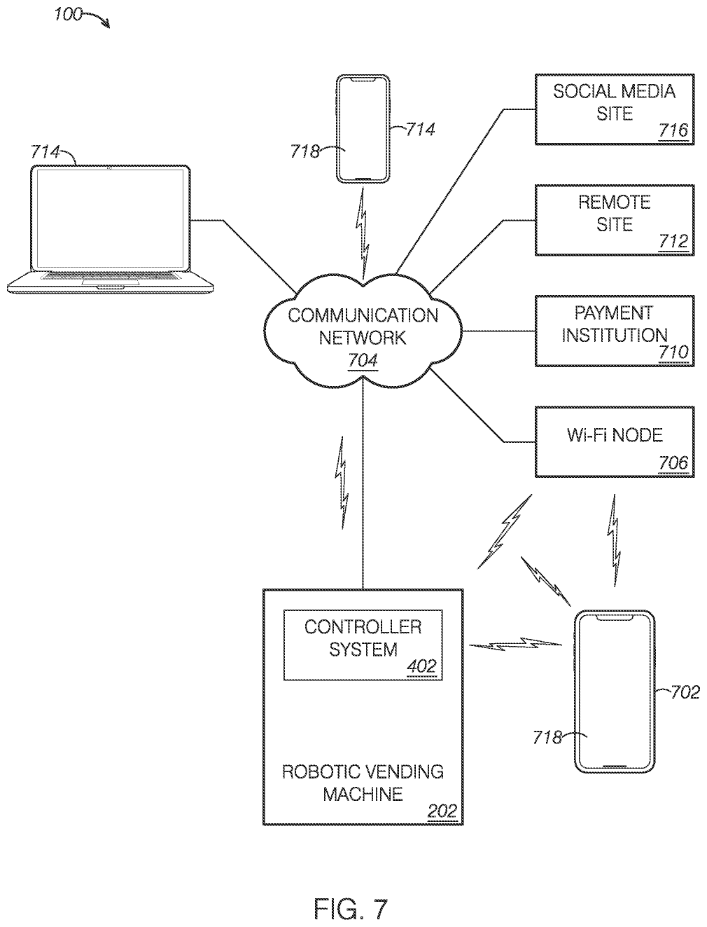

FIG. 7 is a block diagram illustrating components of the robotic vending machine system 100 and various electronic devices that the robotic vending machine system 100 is communicatively to. There, the robotic vending machine 102 is communicatively coupled to a mobile device of the user, such as the example smart phone 702, to a communication network 704, and/or to a Wi-Fi node 706. Here, the robotic vending machine 102 may wirelessly communicate with the smart phone 702 using a suitable wireless signal 708. The robotic vending machine 102 may communicate with the communication network 704 and/or the Wi-Fi node 706 using a suitable wireless signal and/or a wire-based signal.

In a preferred embodiment, the food product information is communicated from the controller system 402 to the mobile device 702. Then the product information, and other information, may be presented on a display 718 of the mobile device 702.

In a preferred embodiments, the robotic vending machine system 100 incudes a smart phone app or the like that the user 202 may download to their mobile electronic device 702. Additionally, or alternatively, an app-like program may be downloaded into the user's remote device 714. Alternatively, text messages or the like may be used to provide information to the user's mobile electronic device 702. Any mobile device, now known or later developed, are intended to be included within the scope of this disclosure and to be protected by the accompanying claims.

In some embodiments, an optional Wi-fi transceiver 626 (FIG. 6) is included to enable the controller system 402 to communicate with nearby electronic devices. For example, the Wi-fi transceiver 626 may enable the robotic vending machine 102 to communicate with a mobile electronic device of the user 202, such as their smart phone 702. The robotic vending machine 102 may communicate food product information (dietary information, caloric information, and/or nutritional information) to the user, may receive ingredient selections from the user's mobile device 702, and/or may receive payment information from the user's mobile device 702. Alternatively, or additionally, the robotic vending machine 102 may use the Wi-fi transceiver 626 to wirelessly couple to a Wi-fi node 706 to access the Internet or another communication network 704.

Alternatively, or additionally, some embodiments may include an optional wireless transceiver 628. The wireless transceiver 628 may enable the robotic vending machine 102 to communicatively couple to a cellular telephony system or the like. Accordingly, food product information (dietary information, caloric information, and/or nutritional information) may be communicated to the user, ingredient selections may be received from the user's mobile device 702 or another remote device 712, 714, 716, and/or payment information may be received from the user's mobile device or another electronic device, such as the payment institution 710 that is operated by a credit card company or a bank.

The communication network 704 is illustrated as a generic communication system. In one embodiment, the communication network 704 comprises a cellular telephone system, such as a radio frequency (RF) wireless system. Accordingly, the robotic vending machine 102 includes a suitable transceiver 630 (FIG. 6). Alternatively, the communication network 704 may be a telephony system, the Internet, a Wi-fi system, a microwave communication system, a fiber optics system, art intranet system, a local access network (LAN) system, an Ethernet system, a cable system, a radio frequency system, a cellular system, an infrared system, a satellite system, or a hybrid system comprised of multiple types of communication media. Additionally, robotic vending machine 102 embodiments may be implemented to communicate using other types of communication technologies, such as but not limited to, digital subscriber loop (DSL), X.25, Internet Protocol (IP), Ethernet, Integrated Services Digital Network (ISDN) and asynchronous transfer mode (ATM). Also, robotic vending machine 102 embodiments may be configured to communicate over combination systems having a plurality of segments which employ different formats for each segment that employ different technologies on each segment.

In some embodiments, the robotic vending machine system 100 may establish connectivity, via the communication network 704, to a remote site 712 that is a component of the robotic vending machine system 100. Various fUnctions may be performed at the remote site 712. For example, the remote site 712 may store historical purchase and order activity of the user 202. When the user 202 is recognized or is identified to the robotic vending machine system 100, pertinent information about the user's past purchases, and/or food produce information (dietary information, caloric information, and/or nutritional information) relating to past purchases, may be communicated to the robotic vending machine 102 and/or the user's smart phone 702. The user's dietary restrictions, allergies, preferences, and/or other personal medical history may be communicated to the controller system 402. The information may then be presented to the user to aid their current purchase and/or to inform the user of their past usage of the robotic vending machine system 100. For example, the information may be presented to the user 202 in a table or bar chart format, and/or by using textual information. Further, if multiple robotic vending machines 102 are available, the information may be provided to the particular robotic vending machine 102 that the user 202 is currently using.

As another example, the robotic vending machine 102 may communicate inventory related information. Restocking orders and/or replacement of out-of-date ingredients may be initiated at the remote site 712. If one or more components of the robotic vending machine 102 fail, or start to fail, a troubleshooting request or report may be generated by the controller system 402 and then be communicate to the remote site 712.

In some instances, the robotic vending machine 102 may establish connectivity, via the communication network 704, with a remote electronic device 714 of the user 202, Example types of the remote electronic device 714 may include a desktop computer, a personal computer, a laptop computer, a smart watch, a notebook or the like. The remote electronic device 714 may even be another person's mobile electronic device. For example, order and/or payment receipts may be generated by the robotic vending machine 102 and communicated to the remote electronic device 714.

For example, a parent of a child user 202 may monitor and/or may pre-authorize payment of the child's purchase. Here, once the child's order has been specified, the parent using their remote device 714 may approve the order and complete payment. The parent may even choose to modify the order by specifying ingredients and/or by deleting ingredients using their remote device 714.

As another non-limiting example, pertinent information about the user's past purchases, and/or food product information (dietary information, caloric information, and/or nutritional information) relating to past purchases, may be communicated from the robotic vending machine 102 (and/or the remote site 712). As another example, a recipe used by the robotic vending machine 102 to prepare the user's prepared food may be communicated to the remote electronic device 714 (and/or the smart phone 702 and/or a smart watch).

In some instances, the robotic vending machine 102 may establish connectivity, via the communication network 704, with a social media site 716 that is of interest to the user 202. Alternatively, or additionally, the remote site 712 may establish connectivity with the social media site 706. In response to a user request, information pertaining to the order of the user 202 and the identity of the user 202 is communicated to the social media site 712.

For example, the user 202 may want to post images, comments, recommendations or the like regarding their prepared food product on the social media site 716. Further, food produce information (dietary information, caloric information, and/or nutritional information), location information for the robotic vending machine system 100, recipes, or the like may be posted on the social media site 716. As another example, other users of the social media system may have favorites (or dislikes) that the user 202 may become aware of from the social media site. The social media site information may be communicated to the robotic vending machine system 100 by the user 202 and/or the social media site 716. For example, if a friend has a strong preference for a particular recipe for a prepared food product, that recipe may be communicated to the robotic vending machine system 100 so that the user 202 can obtain a prepared food product that is prepared in accordance with the recipe. As another example, a stored captured video of the preparation of the food product may be posted on the social media site 716 and/or may be communicated to another electronic device 714 or the user 202 or another person.

Some embodiments of the robotic vending machine system 100 may be configured to provide coupons, promotions, rewards, incentives or the like to the user 202 when they are preparing their customized food product order. Such coupons, promotions, rewards, incentives or the like can be communicated from the remote site 716 to the particular robotic vending machine system 100 that the user 202 is suing. The coupons, promotions, rewards, incentives or the like may even be personalized for that particular user 202.

In some embodiments, the code 116 expires after some predefined time, such as a few minutes, an hour, several hours, a day, or multiple days. Such a feature may provide confidentiality, privacy, and/or security to the user 202. For example, if the user throws the empty container 114 into the garbage after consumption of the prepared food product, another party is not able to obtain the empty container 114 and scan or photograph the code 116 to obtain information pertaining to the user's order.

It should be emphasized that the above-described embodiments of the robotic vending machine system 100 are merely possible examples of implementations of the invention. Many variations and modifications may be made to the above-described embodiments. All such modifications and variations are intended to be included herein within the scope of this disclosure and protected by the following claims. For example, the robotic vending machine system 100 may be configured to dispense salads, smoothies, soups, coffee, ice cream, yogurt, sandwiches, pizza or the like.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Therefore, having thus described the invention, at least the following is claimed:

1. A vending machine, comprising:
a plurality of food tanks,
wherein each food tank is configured to receive, store, and dispense a unique food product, and
wherein each food tank is uniquely associated with a food product identifier that identifies the food product residing in that food tank;
a user interface,
wherein the user interface is configured to present the food product identifiers for the food product in each of the plurality of food tanks on a display to a user, and
wherein the user interface is configured to receive a plurality of user selections of a plurality of food products of interest from the user;
a robotic system,
wherein the robotic system is configured to transport a container to the plurality of food tanks to receive food products dispensed from selected ones of the plurality of food tanks, and
wherein a unique machine readable code is printed on an outside surface of at least one of the container and a container seal;
a scanner configured to scan the machine readable code; and
a controller system communicatively coupled to the user interface, the robotic system, and the scanner,
wherein the controller system controls the robotic system so that the container receives the dispensed plurality of food products of interest;
wherein prior to delivery of the container with the machine readable code, the controller system controls the robotic system so that the scanner acquires the machine readable code,
wherein the controller system receives code information corresponding to the machine readable code from the scanner,
wherein the controller system associates at least food product information with the received code information, and
wherein, after the machine readable code has been acquired, the robotic system is configured to transport the container with the machine readable code to a dispenser for delivery to the user after all of the selected plurality of food products of interest have been dispensed into the container.

2. The vending machine of claim 1,
wherein the controller system is configured to communicatively couple to a mobile electronic device of the user,
wherein response to the user scanning or photographing the machine readable code, the controller system communicates at least the food product information to the mobile electronic device of the user, and
wherein a display of the mobile electronic device of the user presents the product information to the user.

3. The vending machine of claim 2, further comprising:
a Wi-Fi transceiver,
wherein the Wi-Fi transceiver communicatively couples the controller system with the mobile electronic device of the user.

4. The vending machine of claim 2, further comprising:
an Internet interface,
wherein the internet interface communicatively couples the controller system with the mobile electronic device of the user via the Internet.

5. The vending machine of claim 1,
wherein the controller system is communicatively coupled to a remote site, and
wherein the food product information and the associated code information is communicated to the remote site for storage.

6. The vending machine of claim 5,
wherein the remote site is communicatively coupled to a social media site,
wherein response to a user request, the food product information and an identity of the user is communicated from the remote site to the social media site, and
wherein at least the food product information is posted on the social media site.

7. The vending machine of claim 1,
wherein the controller system is communicatively coupled to a social media site,
wherein response to a user request, the food product information and an identity of the user is communicated from the controller system to the social media site, and
wherein at least the food product information is posted on the social media site.

8. The vending machine of claim 1, further comprising:
a memory communicatively coupled to the controller system,
wherein the memory includes a memory region for storing nutrition information associated with the food product contained in each one of the plurality of food tanks,
wherein the controller system accesses the nutrition information associated with each one of the selected plurality of food products of interest, and
wherein the accessed nutrition information for each one of the selected plurality of food products of interest is presented on a display of the vending machine to the user.

9. The vending machine of claim 8,
wherein prior to the user's selection of the plurality of food products of interest, the controller system accesses the nutrition data associated with the food product in each one of the plurality of food tanks, and
wherein the accessed nutrition data for the food product in each one of the plurality of food tanks is presented on the display to the user.

10. The vending machine of claim 8, further comprising:
a transceiver communicatively coupled to the controller system,
wherein the controller system communicates, via the Wi-Fi transceiver, the nutrition information associated with the selected plurality of food products of interest to a mobile electronic device of the user, and
wherein the nutrition information associated with the selected plurality of food products of interest is presented on a display of the mobile electronic device to the user.

11. The vending machine of claim 8, further comprising:
a wireless transceiver communicatively coupled to the controller system and communicatively coupled to a wireless network,
wherein the controller system communicates, via the wireless transceiver and the wireless network, the nutrition information associated with the selected plurality of food products of interest to the mobile electronic device of the user, and
wherein the nutrition information associated with the selected plurality of food products of interest is presented on a display of the mobile electronic device to the user.

12. The vending machine of claim 8, further comprising:
an interact interface communicatively coupled to the controller system and communicatively coupled to the Internet,
wherein the controller system communicates, via the internet interface, the nutrition information associated with the selected plurality of food products of interest to a social media internet server associated with the user,
wherein the nutrition information associated with the selected plurality of food products of interest is communicated from the social media internet server to a mobile electronic device of the user, and
wherein the nutrition information associated with the selected plurality of food products of interest is presented on a display of the mobile electronic device to the user.

13. The vending machine of claim 1, further comprising:
a standing mat communicatively coupled to the controller system,
wherein the standing mat detects an initial presence of the user, and
wherein the user interface initially presents the food product identifiers for the food product in at least one of the plurality of food tanks on the user interface to the user in response to detecting the initial presence of the user.

14. The vending machine of claim 1, wherein the user interface comprises:
a display communicatively coupled to the controller system,
wherein the display presents the food product identifiers for the food product in each of the plurality of food tanks,
wherein the controller system computes a projected billing price as each one of the plurality of food products of interest is selected by the user, and
wherein the display presents the projected billing price to the user in response to each selection made for one of the plurality of food products of interest.

15. The vending machine of claim 14, wherein the display is a touch sensitive display that is configured to receive the user input identifying the plurality of food products of interest in response to a user touch on the touch sensitive display in proximity to the presented food product identifiers for the food product in each of the plurality of food tanks.

16. The vending machine of claim 1, further comprising:
a camera communicatively coupled to the controller system,
wherein the captures video information showing the preparation of the plurality of food products of interest,
wherein the video information is associated with the machine readable code, and
wherein the video information is presented on a display to the user.

17. The vending machine of claim 16, further comprising:
at least one selected from a group consisting of a Wi-Fi transceiver communicatively coupled to the processor, a wireless transceiver communicatively coupled to the controller system and communicatively coupled to a wireless network, and an interact interface communicatively coupled to the controller system and communicatively coupled to the Internet,
wherein the controller system communicates, via the Wi-Fi transceiver, the wireless transceiver or the internet interface, the video information to a mobile electronic device of the user.

18. The vending machine of claim 16, further comprising:
at least one selected from a group consisting of a Wi-Fi transceiver communicatively coupled to the processor, a wireless transceiver communicatively coupled to the controller system and communicatively coupled to a wireless network, and an internet interface communicatively coupled to the controller system and communicatively coupled to the Internet,
wherein the controller system communicates, via the Wi-Fi transceiver, the wireless transceiver or the internet interface, information identifying the user and the video information to a social media system used by the user.

19. The vending machine of claim 1, wherein a unique code is printed on an outside surface of the container, and further comprising:
a memory communicatively coupled to the controller system,
wherein the controller system associates the information identifying the plurality of food products of interest, the machine readable code and user identity information that identifies the user, and
wherein the associated information identifying the plurality of food products of interest, the machine readable code and the user identity information is saved into the memory.

20. The vending machine of claim 1, wherein the plurality of food products of interest are combined to create at least one selected from a group consisting of a smoothie, a salad, a soup, a beverage, ice cream, sandwiches, pizza, and yogurt.
